(19) United States
(12) Patent Application Publication
(10) Pub. No.: US 2021/0003165 A1
(43) Pub. Date: Jan. 7, 2021

(54) DUMBBELL-LIKE AND OLIVE-LIKE ASYMMETRICAL BIDIRECTIONAL TAPERED THREAD CONNECTION PAIRS

(71) Applicant: AMICUS VERITATIS MACHINERY CO., LTD., Taizhou (CN)

(72) Inventor: Yihua You, Taizhou (CN)

(73) Assignee: AMICUS VERITATIS MACHINERY CO., LTD.

(21) Appl. No.: 17/031,162

(22) Filed: Sep. 24, 2020

Related U.S. Application Data
(63) Continuation of application No. PCT/CN2019/081403, filed on Apr. 4, 2019.

(30) Foreign Application Priority Data
Apr. 7, 2018 (CN) 201810303106.7

(51) Int. Cl. F16B 35/04

(52) U.S. Cl. CPC F16B 35/047

(57) ABSTRACT

The present disclosure belongs to the technical field of general technology of devices, and relates to olive-like and dumbbell-like asymmetric bidirectional tapered thread connection pairs, which solve the problems of poor self-positioning and self-locking performance of existing threads. An internal thread (6) is a bidirectional tapered hole (41) (non-entity space) in an inner surface of a cylindrical body (2); an external thread (9) is a bidirectional truncated cone body (71) (material entity) on an outer surface of a columnar body (3); and a complete unit thread is a bidirectional tapered body in an olive-like shape (93) and with a left taper (95) greater than a right taper (96) and/or in a dumbbell-like (94) shape and with the left taper (95) smaller than the right taper (96).

### CROSS-REFERENCE TO RELATED APPLICATIONS

This application is a continuation of International Patent Application No. PCT/CN2019/081403, filed on Apr. 4, 2019, entitled “Dumbbell-Like and Olive-Like Asymmetrical Bidirectional Tapered Thread Connection Pairs”, which claims priority to China Patent Application No. 201810303106.7, filed on Apr. 7, 2018. The content of these identified applications are hereby incorporated by references.

### TECHNICAL FIELD

The present disclosure belongs to the technical field of general technology of device, and particularly relates to dumbbell-like and olive-like asymmetric bidirectional tapered thread connection pair (hereinafter referred to as “bidirectional tapered thread connection pair”).

### BACKGROUND OF THE PRESENT DISCLOSURE

The invention of thread has a profound impact on the progress of human society. Thread is one of the most basic industrial technologies. It is not a specific product, but a key generic technology in the industry. It has the technical performance that must be embodied by specific products as application carriers, and is widely applied in various industries. The existing thread technology has high standardization level, mature technical theory and long-term practical application. It is a fastening thread when used for fastening, a sealing thread when used for sealing, and a transmission thread when used for transmission. According to the thread terminology of national standards, the “thread” refers to thread bodies having the same thread profile and continuously protruding along a helical line on a cylindrical or conical surface; and the “thread body” refers to a material entity between adjacent flanks. This is also the definition of thread under global consensus.

The modern thread began in 1841 with British Whitworth thread. According to the theory of modern thread technology, the basic condition for self-locking of the thread is that an equivalent friction angle shall not be smaller than a helical rise angle. This is an understanding for the thread technology in modern thread based on a technical principle-“principle of inclined plane”, which has become an important theoretical basis of the modern thread technology. Simon Stevin was the first to explain the principle of inclined plane theoretically. He has researched and discovered the parallelogram law for balancing conditions and force composition of objects on the inclined plane. In 1586, he put forward the famous law of inclined plane that the gravity of an object placed on the inclined plane in the direction of inclined plane is proportional to the sine of inclination angle. The inclined plane refers to a smooth plane inclined to the horizontal plane; the helix is a deformation of the “inclined plane”; the thread is like an inclined plane wrapped around the cylinder; and the flatter the inclined plane is, the greater the mechanical advantage is (see FIG. 7) (Jingshan Yang and Xiuya Wang, Discussion on the Principle of Screws, Disquisitiones Arithmeticae of Gauss).

The “principle of inclined plane” of the modern thread is an inclined plane slider model (see FIG. 8) which is established based on the law of inclined plane. It is believed that the thread pair meets the requirements of self-locking when a thread rise angle is less than or equal to the equivalent friction angle under the condition of little change of static load and temperature. The thread rise angle (see FIG. 9), also known as thread lead angle, is an angle between a tangent line of a helical line on a pitch-diameter cylinder and a plane perpendicular to a thread axis; and the angle affects the self-locking and anti-loosening of the thread. The equivalent friction angle is a corresponding friction angle when different friction forms are finally transformed into the most common inclined plane slider form. Generally, in the inclined plane slider model, when the inclined plane is inclined to a certain angle, the friction force of the slider at this time is exactly equal to the component of gravity along the inclined plane; the object is just in a state of force balance at this time; and the inclination angle of the inclined plane at this time is called the equivalent friction angle.

American engineers invented the wedge thread in the middle of last century; and the technical principle of the wedge thread still follows the “principle of inclined plane”. The disclosure of the wedge thread was inspired by the “wooden wedge”. Specifically, the wedge thread has a structure that a wedge-shaped inclined plane forming an angle of 25°-30° with the thread axis is located at the root of internal threads (i.e., nut threads) of triangular threads (commonly known as common threads); and a wedge-shaped inclined plane of 30° is adopted in engineering practice. For a long time, people have studied and solved the anti-loosening and other problems of the thread from the technical level and technical direction of thread profile angle. The wedge thread technology is also a specific application of the inclined wedge technology without exception.

The modern threads are abundant in types and forms, and are all tooth-shaped threads, which are determined by the technical principle, i.e., the principle of inclined plane. Specifically, the thread formed on a cylindrical surface is called cylindrical thread; the thread formed on a conical surface is called conical thread; and the thread formed on an end surface of the cylinder or the truncated cone is called plane thread. The thread formed on the surface of an outer circle of the body is called external thread; the thread formed on the surface of an inner round hole of the body is called internal thread; and the thread formed on the end surface of the body is called end face thread. The thread that the helical direction and the thread rise angle direction conform to the left-hand rule is called left-hand thread; and the thread that the helical direction and the thread rise angle direction conform to the right-hand rule is called right-hand thread. The thread having only one helical line in the same cross section of the body is called single-start thread; the thread having two helical lines is called double-start thread; and the thread having multiple helical lines is called multi-start thread. The thread having a triangular cross section is called triangular thread; the thread having a trapezoidal cross section is called trapezoidal thread; the thread having a rectangular cross section is called rectangular thread; and the thread having a zigzag cross section is called zigzag thread.

However, the existing threads have the problems of low connection strength, weak self-positioning ability, poor self-locking performance, low bearing capacity, poor stability, poor compatibility, poor reusability, high temperature and low temperature and the like. Typically, bolts or nuts using the modern thread technology generally have the defect of easy loosening. With the frequent vibration or shaking of equipment, the bolts and the nuts become loose or even fall off, which easily causes safety accidents in serious cases.

### SUMMARY OF PRESENT DISCLOSURE

Any technical theory has theoretical hypothesis background; and the thread is not an exception. With the development of science and technology, the damage to connection is not simple linear load, static or room temperature environment; and linear load, nonlinear load and even the superposition of the two cause more complex load damaging conditions and complex application conditions. Based on such recognition, the object of the present disclosure is to provide dumbbell-like and olive-like asymmetric bidirectional tapered thread connection pairs with reasonable design, simple structure, and excellent connection performance and locking performance with respect to the above problems.

To achieve the above object, the following technical solution is adopted in the present disclosure: the dumbbell-like and olive-like asymmetric bidirectional tapered thread connection pairs are used in such a manner that asymmetric bidirectional tapered external threads and asymmetric bidirectional tapered internal threads form a thread connection pair, and is a thread pair technology combining technical characteristics of a cone pair and a helical movement. The bidirectional tapered thread is a thread technology combining the technical characteristics of a bidirectional tapered body and a helical structure. The bidirectional tapered body is composed of two single tapered bodies. The two single tapered bodies are respectively located on the left and right sides of the bidirectional tapered body, i.e., the bidirectional tapered body is composed of two single tapered bodies with left tapers and right tapers reverse and/or opposite in direction and different in taper in two directions. The bidirectional tapered body is helically distributed on the outer surface of a columnar body to form the external threads; and/or the bidirectional tapered body is helically distributed on the inner surface of a cylindrical body to form internal threads. A complete unit thread is a bidirectional tapered geometric structure, comprising two special bidirectional tapered geometric structure; one is shaped like an olive and the other is shaped like a dumbbell. Namely, the complete unit thread of the bidirectional tapered thread comprises an olive-like shaped bidirectional tapered thread and a dumbbell-like bidirectional tapered thread.

In the bidirectional tapered thread connection pair, the definition of the asymmetric bidirectional tapered thread can be expressed as “a special helical bidirectional tapered geometry, including the olive-like shaped bidirectional tapered geometry and the dumbbell-like shaped bidirectional tapered geometry, which has the asymmetric bidirectional tapered holes (or asymmetric bidirectional truncated cone bodies) with the specified left and right tapers reverse or opposite in direction and different in taper and is continuously (or discontinuously) distributed along the helical line”. The head and the tail of the asymmetric bidirectional tapered thread may be incomplete bidirectional tapered geometries due to manufacturing and other reasons. Different from the modern thread technology, in terms of the quantity title of complete unit thread and/or incomplete unit thread, the bidirectional tapered thread is not based on “the number of threads” but based on “the number of pitches”, i.e., is not be called a (the number of threads) thread but called (the number of pitches)-pitch thread. The quantity title of the thread is changed on the basis of the change of technical connotation. The thread technology has changed from the engagement relationship between the internal threads and the external threads of the modern threads to the cohesion relationship between the internal threads and the external threads of the bidirectional tapered threads. Regardless of internal thread and external thread, the bidirectional tapered thread has two forms of complete single-pitch thread, wherein one is a special bidirectional tapered geometry in an olive-like shape and with a large middle and two small ends, and the other is a special bidirectional tapered geometry in a dumbbell-like shape and with a small middle and two large ends. The two forms are the same in technical principle, but different in structural forms.

The bidirectional tapered thread connection pair comprises a bidirectional truncated cone body helically distributed on an outer surface of a columnar body and a bidirectional tapered hole helically distributed in an inner surface of a cylindrical body, namely, comprises an external thread and an internal thread which are in threaded fitting with each other. The internal thread is distributed as a helical bidirectional tapered hole; and the external thread is distributed as a helical bidirectional truncated cone body. The internal thread is in the form of helical bidirectional tapered hole (non-entity space); and the external thread is in the form of helical bidirectional truncated cone body (material entity). The non-entity space refers to a space environment capable of accommodating the above material entity. The internal thread is a containing part; and the external thread is a contained part. The threads work in such a state that the internal thread and the external thread are fitted together by screwing the two bidirectional tapered geometries pitch by pitch, and the internal thread is fitted with the external thread till one side bears the load bidirectionally or both the left side and the right side bear the load bidirectionally at the same time or till the external thread and the internal thread are in interference fit. Whether the two sides bear bidirectional load at the same time is related to the actual working conditions in the application field, i.e., the bidirectional tapered hole contains the bidirectional truncated cone body pitch by pitch, i.e., the internal thread is fitted with the corresponding external thread pitch by pitch.

The thread connection pair is a thread pair formed by fitting a helical outer conical surface with a helical inner conical surface to form a cone pair. In the bidirectional tapered thread, both the outer conical surface of the external cone body and the inner conical surface of the internal cone body are bidirectional conical surfaces. When the thread connection pair is formed between the bidirectional tapered threads, a joint surface between the inner conical surface and the outer conical surface is used as a bearing surface. Namely, the conical surface is used as the bearing surface to realize the technical performance of connection. The self-locking, self-positioning, reusability, fatigue resistance and other capabilities of the thread pair mainly depend on the size of conical surfaces and tapers of the cone pair forming the asymmetric bidirectional tapered thread connection pair, i.e., the size of conical surfaces and tapers of the internal thread and the external thread. The thread pair is a non-toothed thread.

Different from that the principle of inclined plane of the existing thread which shows a unidirectional force distributed on the inclined plane as well as an engagement relationship between the internal tooth bodies and the external tooth bodies, the bidirectional tapered thread connection pair is composed of two plain lines of the cone body in two directions through a cross section of a cone axis, i.e., in a bidirectional state. The plain lines are intersection lines of the conical surfaces and a plane through which the cone axis passes through. The cone principle of the asymmetric bidirectional tapered thread connection pair shows an axial force and a counter-axial force, both of which are combined by bidirectional forces. The axial force and the corresponding counter-axial force are opposite to each other. The internal thread and the external thread are in a cohesion relationship, i.e., the thread pair is formed by cohering the external thread with the internal thread, i.e., the tapered hole (internal cone) is fitted with the corresponding tapered cone body (external cone body) pitch by pitch till the self-positioning is realized by cohesion sizing fit or till the self-locking is realized by interference contact. Namely, the self-locking or self-positioning of the internal cone body and the external cone body is realized by radially cohering the tapered hole and the truncated cone body to realize the self-locking or self-positioning of the thread pair, rather than the thread connection pair composed of the internal thread and the external thread in the traditional thread, which realizes its connection performance by mutual abutment between the tooth bodies. This is a working relationship state of the internal thread and the external thread of the thread technology of the present disclosure.

A self-locking force will arise when the cohesion process between the internal thread and the external thread reaches certain conditions. The self-locking force is generated by the pressure produced between the axial force of the internal cone and the counter-axial force of the external cone. Namely, when the internal cone and the external cone form the cone pair, the inner conical surface of the internal cone body is fitted with the outer conical surface of the external cone body; and the inner conical surface is in close contact with the outer conical surface. The axial force of the internal cone and the counter-axial force of the external cone are concepts of forces unique to the bidirectional tapered thread technology of the present disclosure, i.e., the cone pair technology.

The internal cone body exists in a form similar to a shaft sleeve, and generates the axial force pointing to or pressing toward the cone axis under the action of external load. The axial force is bidirectionally combined by a pair of centripetal forces which are distributed in mirror image with the cone axis as a center and are respectively perpendicular to the two plain lines of the cone body; i.e., the axial force passes through the cross section of the cone axis and is composed of two centripetal forces which are bidirectionally distributed on two sides of the cone axis in mirror image with the cone axis as the center, are respectively perpendicular to the two plain lines of the cone body, and point to or press toward a common point of the cone axis; and the axial force passes through the cross section of a thread axis and is composed of two centripetal forces which are bidirectionally distributed on two sides of the thread axis in mirror image and/or approximate mirror image with the thread axis as the center, are respectively perpendicular to two plain lines of the cone body, and point to or press toward the common point and/or approximate common point of the thread axis when the thread is combined by the cone body and the helical structure and is applied to the thread pair. The axial force is densely distributed on the cone axis and/or the thread axis in an axial and circumferential manner, and corresponds to an axial force angle. The axial force angle is formed by an angle between two centripetal forces forming the axial force and depends on the taper of the cone body, i.e., the taper angle.

The external cone body exists in a form similar to a shaft, has relatively strong ability to absorb various external loads, and generates the counter-axial force opposite to each axial force of the internal cone body. The counter-axial force is bidirectionally combined by a pair of counter-centripetal forces which are distributed in mirror image with the cone axis as a center and are respectively perpendicular to the two plain lines of the cone body; i.e., the counter-axial force passes through the cross section of the cone axis and is composed of two counter-centripetal forces which are bidirectionally distributed on two sides of the cone axis in mirror image with the cone axis as the center, are respectively perpendicular to the two plain lines of the cone body, and point to or press toward the common point of the cone axis; and the counter-axial force passes through the cross section of a thread axis and is composed of two counter-centripetal forces which are bidirectionally distributed on two sides of the thread axis in mirror image and/or approximate mirror image with the thread axis as the center, are respectively perpendicular to two plain lines of the cone body, and point to or press toward the common point and/or approximate common point of the thread axis when the thread is combined by the cone body and the helical structure and is applied to the thread pair. The counter-axial force is densely distributed on the cone axis and/or the thread axis in the axial and circumferential manner, and corresponds to a counter-axial force angle. The counter-axial force angle is formed by an angle between two counter-centripetal forces forming the counter-axial force and depends on the taper of the cone body, i.e., the taper angle.

The axial force and the counter-axial force start to be generated when the internal cone and the external cone of the cone pair are in effective contact, i.e., a pair of corresponding and opposite axial force and counter-axial force always exist during effective contact of the internal cone and the external cone of the cone pair. The axial force and the counter-axial force are bidirectional forces bidirectionally distributed in mirror image with the cone axis and/or the thread axis as the center, rather than unidirectional forces. The cone axis and the thread axis are coincident axes, i.e., the same axis and/or approximately the same axis. The counter-axial force and the axial force are reversely collinear and are reversely collinear and/or approximately reversely collinear when the cone body and the helical structure are combined into the thread and form the thread pair. The internal cone and the external cone are fitted till interference is achieved, so the axial force and the counter-axial force generate the pressure on the contact surface between the inner conical surface and the outer conical surface and are densely and uniformly distributed on the contact surface between the inner conical surface and the outer conical surface axially and circumferentially. When the cohesion movement of the internal cone and the external cone continues till the cone pair reaches the pressure generated by interference fit to combine the internal cone with the external cone, i.e., the pressure enables the internal cone body to be fitted with the external cone body to form a similar integral structure and will not cause the internal cone body and the external cone body to separate from each other under the action of gravity due to the arbitrary change in the direction of the body position of the similar integral structure after the external force caused by the pressure disappears, the cone pair generates self-locking, which means that the thread pair generates self-locking. The self-locking performance has a certain degree of resistance to other external loads which may cause the internal cone body and the external cone body to separate from each other except gravity. The cone pair also has the self-positioning performance which enables the internal cone and the external cone to be fitted with each other, but not any axial force angle and/or counter-axial force angle can make the cone pair generate self-locking and self-positioning.

When the axial force angle and/or the counter-axial force angle is less than 180° and greater than 127°, the cone pair has the self-locking performance. When the axial force angle and/or the counter-axial force angle is infinitely close to 180°, the cone pair has the best self-locking performance and the weakest axial bearing capacity. When the axial force angle and/or the counter-axial force angle is equal to and/or less than 127° and greater than 0°, the cone pair is in a range of weak self-locking performance and/or no self-locking performance. When the axial force angle and/or the counter-axial force angle tends to change in a direction infinitely close to 0°, the self-locking performance of the cone pair changes in a direction of attenuation till the cone pair completely has no self-locking ability; and the axial bearing capacity changes in a direction of enhancement till the axial bearing capacity is the strongest.

When the axial force angle and/or the counter-axial force angle is less than 180° and greater than 127°, the cone pair is in a strong self-positioning state, and the strong self-positioning of the internal cone body and the external cone body is easily achieved. When the axial force angle and/or the counter-axial force angle is infinitely close to 180°, the internal cone body and the external cone body of the cone pair have the strongest self-positioning ability. When the axial force angle and/or the counter-axial force angle is equal to and/or less than 127° and greater than 0°, the cone pair is in a weak self-positioning state. When the axial force angle and/or the counter-axial force angle tends to change in the direction infinitely close to 0°, the mutual self-positioning ability of the internal cone body and the external cone body of the cone pair changes in the direction of attenuation till the cone pair approximately completely has no self-positioning ability.

The relationship between the axial force and the counter-axial force determines a threaded mechanical structure such as the bidirectional tapered thread. The internal thread and the external thread are subjected to a containing and contained relationship. Compared with the containing and contained relationship of irreversible one-sided bidirectional containment that the unidirectional tapered thread of single tapered body invented by the applicant before can only bear the load by one side of the conical surface, the reversible left and right-sided bidirectional containment of the bidirectional tapered threads of double tapered bodies enables the left side and/or the right side of the conical surface to bear the load, and/or the left conical surface and the right conical surface to respectively bear the load, and/or the left conical surface and the right conical surface to simultaneously bear the load bidirectionally, and further limits the disordered degree of freedom between the tapered hole and the truncated cone body; and the helical movement enables the asymmetric bidirectional tapered thread connection pair to obtain the necessary ordered degree of freedom, thereby effectively synthesizing the technical characteristics of the cone pair and the thread pair to form a brand-new thread technology.

When the bidirectional tapered thread connection pair is used, the conical surface of the bidirectional truncated cone body of the external thread of the bidirectional tapered thread and the conical surface of the bidirectional tapered hole of the internal thread of the bidirectional tapered thread are fitted with each other.

The self-locking or self-positioning of the thread connection pair is not realized at any taper or any taper angle of the bidirectional tapered thread of the bidirectional tapered thread connection pair. The asymmetric bidirectional tapered thread connection pair has the self-locking and self-positioning performances only if the internal cone body and/or the external cone body, i.e., the truncated cone body and/or the tapered hole reaches a certain taper. The taper comprises the left taper and the right taper of the internal thread and the external thread. The bidirectional tapered thread connection pair is composed of two forms of bidirectional tapered threads, wherein one is that the left taper of the bidirectional tapered thread is greater than the right taper, i.e., the right taper is smaller than the left taper; and the other is that the left taper of the bidirectional tapered thread is smaller than the right taper, i.e., the right taper is greater than the left taper.

In the bidirectional tapered thread connection pair, the left taper corresponds to a first taper angle α1; and the right taper corresponds to a second taper angle α2. When the left taper is greater than the right taper, it is preferable that the first taper angle α1 is greater than 0° and smaller than 53°; and preferably, the first taper angle α1 is 2°-40°. In individual special fields, it is preferable that the first taper angle α1 is greater than or equal to 53° and smaller than 180′; and preferably, the first taper angle α1 is 53°-90°. It is preferable that the second taper angle α2 is greater than 0° and smaller than 53°; and preferably, the second taper angle α2 is 2°-40°.

When the left taper is smaller than the right taper, it is preferable that the first taper angle α1 is greater than 0° and smaller than 53°; and preferably, the first taper angle α1 is 2°-40°. It is preferable that the second taper angle α2 is greater than 0° and smaller than 53°; and preferably, the second taper angle α2 is 2°-40°. In individual special fields, it is preferable that the second taper angle α2 is greater than or equal to 53° and smaller than 180°; and preferably, the second taper angle α2 is 53°-90°.

The above-mentioned individual special fields refer to the application fields of thread connection such as transmission connection with low requirements on self-locking performance or even without self-locking performance and/or with low requirements on self-positioning performance and/or with high requirements on axial bearing capacity and/or with indispensable anti-locking measures.

The external thread of the bidirectional tapered thread connection pair is arranged on the outer surface of the columnar body. The truncated cone body is helically distributed on the outer surface of the columnar body, comprising an asymmetric bidirectional truncated cone body. The asymmetric bidirectional truncated cone body has two structural forms, wherein one is a special bidirectional tapered geometry in an olive-like shape with the left taper smaller than the right taper; and the other is a special bidirectional tapered geometry in a dumbbell-like shape and with the left taper greater than the right taper. The columnar body may be solid or hollow, comprising cylindrical and/or non-cylindrical workpieces and objects that need to be machined with threads on the outer surfaces. The outer surfaces comprise cylindrical surfaces, non-cylindrical surfaces such as conical surfaces, and outer surfaces of other geometric shapes.

For the bidirectional tapered thread connection pair, when the asymmetric bidirectional truncated cone body, i.e., the external thread is the special bidirectional tapered geometry in the olive-like shape, lower bottom surfaces of two truncated cone bodies with the same lower bottom surfaces and upper top surfaces and different cone heights are symmetrically and oppositely jointed in a helical shape to form the thread. Namely, when the lower bottom surfaces of two truncated cone bodies with the same lower bottom surfaces and upper top surfaces and different cone heights are jointed with each other, and the upper top surfaces are located at both ends of the bidirectional truncated cone body to form the asymmetric bidirectional tapered thread, the process comprises that the lower bottom surfaces are respectively jointed with the upper top surfaces of the adjacent bidirectional truncated cone bodies and/or to be respectively jointed with the upper top surfaces of the adjacent bidirectional truncated cone bodies in the helical shape to form the thread. The outer surface of the truncated cone body is provided with the conical surface of the asymmetric bidirectional truncated cone body. The external thread comprises a first helical conical surface of the truncated cone body, a second helical conical surface of the truncated cone body and an external helical line, which form an asymmetric bidirectional tapered external thread. In the cross section through which the thread axis passes through, the complete unit thread, i.e., a complete single-pitch asymmetric bidirectional tapered external thread, is a special bidirectional tapered geometry in the olive-like shape and with a large middle and two small ends. The angle formed between the two plain lines of the left conical surface of the asymmetric bidirectional truncated cone body, i.e., the first helical conical surface of the truncated cone body, is the first taper angle, i.e., the left taper angle corresponding to the left taper of the external thread of the asymmetric bidirectional tapered thread. The left taper is subjected to a left-direction distribution. The angle formed between the two plain lines of the right conical surface of the asymmetric bidirectional truncated cone body, i.e., the second helical conical surface of the truncated cone body, is the second taper angle, i.e., the right taper angle corresponding to the right taper of the external thread of the asymmetric bidirectional tapered thread. The right taper is subjected to a right-direction distribution. The taper directions corresponding to the first taper angle and the second taper angle are opposite. The plain line is an intersection line of the conical surface and the plane through which the cone axis passes through. The shape formed by the first helical conical surface and the second helical conical surface of the truncated cone body of the bidirectional truncated cone body is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the columnar body. The right-angled side is coincident with the central axis of the columnar body; and the right-angled trapezoid union is formed by symmetrically and oppositely jointing lower bottom sides of two right-angled trapezoids with the same lower bottom sides and upper sides and different right-angled sides. The right-angled trapezoid union refers to a special geometry, which is formed by symmetrically and oppositely jointing the lower bottom sides of two right-angled trapezoids with the same lower bottom sides and upper sides and different right-angled sides and has the upper sides respectively located at both ends of the right-angled trapezoid union. The left taper is formed by the first helical conical surface of the truncated cone body and corresponds to the first taper angle α1 of the asymmetric bidirectional tapered external thread, i.e., the left taper angle corresponding to the left taper of the external thread of the asymmetric bidirectional tapered thread. The left taper is subjected to the left-direction distribution. The right taper is formed by the second helical conical surface of the truncated cone body and corresponds to the second taper angle α2 of the asymmetric bidirectional tapered external thread, i.e., the right taper angle corresponding to the right taper of the external thread of the asymmetric bidirectional tapered thread. The right taper is subjected to the right-direction distribution. The taper directions corresponding to the first taper angle α1 and the second taper angle α2 are opposite.

For the bidirectional tapered thread connection pair, when the asymmetric bidirectional truncated cone body, i.e., the external thread is the special bidirectional tapered geometry in the dumbbell-like shape, upper top surfaces of two truncated cone bodies with the same lower bottom surfaces and upper top surfaces and different cone heights are symmetrically and oppositely jointed in a helical shape to form the thread. Namely, when the upper top surfaces of two truncated cone bodies with the same lower bottom surfaces and upper top surfaces and different cone heights are jointed with each other, and the lower bottom surfaces are located at both ends of the bidirectional truncated cone body to form the asymmetric bidirectional tapered thread, the process comprises that the upper top surfaces are respectively jointed with the lower bottom surfaces of the adjacent bidirectional truncated cone bodies and/or to be respectively jointed with the lower bottom surfaces of the adjacent bidirectional truncated cone bodies in the helical shape to form the thread. The outer surface of the truncated cone body is provided with the conical surface of the asymmetric bidirectional truncated cone body. The external thread comprises the first helical conical surface of the truncated cone body, the second helical conical surface of the truncated cone body and the external helical line, which form the asymmetric bidirectional tapered external thread. In the cross section through which the thread axis passes through, the complete unit thread, i.e., the complete single-pitch asymmetric bidirectional tapered external thread, is a special bidirectional tapered geometry in the dumbbell-like shape and with a small middle and two large ends. The angle formed between the two plain lines of the left conical surface of the asymmetric bidirectional truncated cone body, i.e., the first helical conical surface of the truncated cone body, is the first taper angle, i.e., the left taper angle corresponding to the left taper of the external thread of the asymmetric bidirectional tapered thread. The left taper is subjected to a right-direction distribution. The angle formed by the two plain lines of the right conical surface of the asymmetric bidirectional truncated cone body, i.e., the second helical conical surface of the truncated cone body, is the second taper angle, i.e., the right taper angle corresponding to the right taper of the external thread of the asymmetric bidirectional tapered thread. The right taper is subjected to a left-direction distribution. The taper directions corresponding to the first taper angle and the second taper angle are opposite. The plain line is an intersection line of the conical surface and the plane through which the cone axis passes through. The shape formed by the first helical conical surface and the second helical conical surface of the truncated cone body of the bidirectional truncated cone body is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the columnar body. The right-angled side is coincident with the central axis of the columnar body; and the right-angled trapezoid union is formed by symmetrically and oppositely jointing upper sides of two right-angled trapezoids with the same lower bottom sides and upper sides and different right-angled sides. The right-angled trapezoid union refers to a special geometry, which is formed by symmetrically and oppositely jointing the upper sides of two right-angled trapezoids with the same lower bottom sides and upper sides and different right-angled sides and has the lower bottom sides respectively located at both ends of the right-angled trapezoid union. The left taper is formed by the first helical conical surface of the truncated cone body and corresponds to the first taper angle α1 of the asymmetric bidirectional tapered external thread, i.e., the left taper of the external thread of the asymmetric bidirectional tapered thread corresponds to the left taper angle and is subjected to the right-direction distribution. The right taper is formed by the second helical conical surface of the truncated cone body and corresponds to the second taper angle α2 of the asymmetric bidirectional tapered external thread, i.e., the right taper of the external thread of the asymmetric bidirectional tapered thread corresponds to the right taper angle and is subjected to the left-direction distribution. The taper directions corresponding to the first taper angle α1 and the second taper angle α2 are opposite.

The internal thread of the bidirectional tapered thread connection pair is arranged on the inner surface of the cylindrical body. The tapered hole is helically distributed in the inner surface of the cylindrical body, comprising the asymmetric bidirectional tapered hole. The asymmetric bidirectional tapered hole has two structural forms, wherein one is a special bidirectional tapered geometry in the olive-like shape and with the left taper smaller than the right taper; and the other is a special bidirectional tapered geometry in the dumbbell-like shape and with the left taper greater than the right taper. The cylindrical body comprises cylindrical and/or non-cylindrical workpieces and objects which need to be machined with the internal threads on the inner surfaces. The inner surfaces comprise cylindrical surfaces, non-cylindrical surfaces such as conical surfaces, and inner surfaces of other geometric shapes.

For the bidirectional tapered thread connection pair, when the asymmetric bidirectional tapered hole, i.e., the internal thread is the special bidirectional tapered geometry in the olive-like shape, lower bottom surfaces of two tapered holes with the same lower bottom surfaces and upper top surfaces and different cone heights are symmetrically and oppositely jointed in a helical shape to form the thread. Namely, when the lower bottom surfaces of two tapered holes with the same lower bottom surfaces and upper top surfaces and different cone heights are jointed with each other, and the upper top surfaces are located at both ends of the bidirectional tapered hole to form the asymmetric bidirectional tapered thread, the process comprises that the lower bottom surfaces are respectively jointed with the upper top surfaces of the adjacent bidirectional tapered holes and/or to be respectively jointed with the upper top surfaces of the adjacent bidirectional tapered holes in the helical shape to form the thread. The tapered hole comprises the conical surface of the asymmetric bidirectional tapered hole. The internal thread comprises a first helical conical surface of the tapered hole, a second helical conical surface of the tapered hole and an internal helical line, which form an asymmetric bidirectional tapered internal thread. In the cross section through which the thread axis passes through, the complete unit thread, i.e., a complete single-pitch asymmetric bidirectional tapered internal thread, is a special bidirectional tapered geometry in the olive-like shape and with a large middle and two small ends. The angle formed by the two plain lines of the left conical surface of the bidirectional tapered hole, i.e., the first helical conical surface of the tapered hole, is the first taper angle, i.e., the left taper angle corresponding to the left taper of the internal thread of the asymmetric bidirectional tapered thread. The left taper is subjected to the left-direction distribution. The angle formed by the two plain lines of the right conical surface of the bidirectional tapered hole, i.e., the second helical conical surface of the tapered hole, is the second taper angle, i.e., the right taper angle corresponding to the right taper of the internal thread of the asymmetric bidirectional tapered thread. The right taper is subjected to the right-direction distribution. The taper directions corresponding to the first taper angle and the second taper angle are opposite. The plain line is an intersection line of the conical surface and the plane through which the cone axis passes through. The shape formed by the first helical conical surface and the second helical conical surface of the tapered hole of the bidirectional tapered hole is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body. The right-angled side is coincident with the central axis of the cylindrical body; and the right-angled trapezoid union is formed by symmetrically and oppositely jointing lower bottom sides of two right-angled trapezoids with the same lower bottom sides and upper sides and different right-angled sides. The right-angled trapezoid union refers to a special geometry, which is formed by symmetrically and oppositely jointing the lower bottom sides of two right-angled trapezoids with the same lower bottom sides and upper sides and different right-angled sides and has the upper sides respectively located at both ends of the right-angled trapezoid union. The left taper is formed by the first helical conical surface of the tapered hole and corresponds to the first taper angle α1 of the asymmetric bidirectional tapered internal thread, i.e., the left taper of the internal thread of the asymmetric bidirectional tapered thread corresponds to the left taper angle and is subjected to the left-direction distribution. The right taper is formed by the second helical conical surface of the tapered hole and corresponds to the second taper angle α2 of the asymmetric bidirectional tapered internal thread, i.e., the right taper of the internal thread of the asymmetric bidirectional tapered thread corresponds to the right taper angle and is subjected to the right-direction distribution. The taper directions corresponding to the first taper angle α1 and the second taper angle α2 are opposite.

For the bidirectional tapered thread connection pair, when the asymmetric bidirectional tapered hole, i.e., the internal thread is the special bidirectional tapered geometry in the dumbbell-like shape, upper top surfaces of two tapered holes with the same lower bottom surfaces and upper top surfaces and different cone heights are symmetrically and oppositely jointed in a helical shape to form the thread. Namely, when the upper top surfaces of two tapered holes with the same lower bottom surfaces and upper top surfaces and different cone heights are jointed with each other, and the lower bottom surfaces are located at both ends of the bidirectional tapered hole to form the asymmetric bidirectional tapered thread, the process comprises that the upper top surfaces are respectively jointed with the lower bottom surfaces of the adjacent bidirectional tapered holes and/or to be respectively jointed with the lower bottom surfaces of the adjacent bidirectional tapered holes in the helical shape to form the thread. The tapered hole comprises the conical surface of the asymmetric bidirectional tapered hole. The internal thread comprises the first helical conical surface of the tapered hole, the second helical conical surface of the tapered hole and the internal helical line, which form the asymmetric bidirectional tapered internal thread. In the cross section through which the thread axis passes through, the complete unit thread, i.e., the complete single-pitch asymmetric bidirectional tapered internal thread, is a special bidirectional tapered geometry in the dumbbell-like shape and with a small middle and two large ends. The angle formed by the two plain lines of the left conical surface of the bidirectional tapered hole, i.e., the first helical conical surface of the tapered hole, is the first taper angle, i.e., the left taper angle corresponding to the left taper of the internal thread of the asymmetric bidirectional tapered thread. The left taper is subjected to the right-direction distribution. The angle formed by the two plain lines of the right conical surface of the bidirectional tapered hole, i.e., the second helical conical surface of the tapered hole, is the second taper angle, i.e., the right taper angle corresponding to the right taper of the internal thread of the asymmetric bidirectional tapered thread. The right taper is subjected to the left-direction distribution. The taper directions corresponding to the first taper angle and the second taper angle are opposite. The plain line is an intersection line of the conical surface and the plane through which the cone axis passes through. The shape formed by the first helical conical surface and the second helical conical surface of the tapered hole of the bidirectional tapered hole is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body. The right-angled side is coincident with the central axis of the cylindrical body; and the right-angled trapezoid union is formed by symmetrically and oppositely jointing upper sides of two right-angled trapezoids with the same lower bottom sides and upper sides and different right-angled sides. The right-angled trapezoid union refers to a special geometry, which is formed by symmetrically and oppositely jointing the upper sides of two right-angled trapezoids with the same lower bottom sides and upper sides and different right-angled sides and has the lower bottom sides respectively located at both ends of the right-angled trapezoid union. The left taper is formed by the first helical conical surface of the tapered hole and corresponds to the first taper angle α1 of the asymmetric bidirectional tapered internal thread, i.e., the left taper angle corresponding to the left taper of the internal thread of the asymmetric bidirectional tapered thread. The left taper is subjected to the right-direction distribution. The right taper is formed by the second helical conical surface of the tapered hole and corresponds to the second taper angle α2 of the asymmetric bidirectional tapered internal thread, i.e., the right taper angle corresponding to the right taper of the internal thread of the asymmetric bidirectional tapered thread. The right taper is subjected to the left-direction distribution. The taper directions corresponding to the first taper angle α1 and the second taper angle α2 are opposite.

In specific application, the bidirectional tapered thread connection pair is used in such a manner that the olive-like asymmetric bidirectional tapered external thread with the left taper greater than the right taper and the dumbbell-like asymmetric bidirectional tapered internal thread with the left taper smaller than the right taper form the thread pair, and/or the dumbbell-like asymmetric bidirectional tapered external thread with the left taper smaller than the right taper and the olive-like asymmetric bidirectional tapered internal thread with the left taper greater than the right taper form the thread pair. Combination of mutually fitted helical conical surfaces serving as thread working support surfaces will change, comprising but not limited to the combination forms of the mutual matching helical conical surfaces that contact surfaces between the first helical conical surface of the tapered hole and the second helical conical surface of the truncated cone body interact as supporting surfaces, and/or contact surfaces between the second helical conical surface of the tapered hole and the first helical conical surface of the truncated cone body interact as supporting surfaces, and/or the left conical surface and the right conical surface bear the load at the same time. However, the technical principle is the same for any combination.

When the bidirectional tapered thread connection pair is used for transmission connection, the bidirectional bearing is implemented through the screwing connection between the bidirectional tapered hole of the bidirectional tapered internal thread and the bidirectional truncated cone body of the bidirectional tapered external thread. When the external thread and the internal thread form the thread pair, a clearance must be reserved between the internal thread and the external thread, i.e., the clearance must be reserved between the bidirectional truncated cone body of the bidirectional tapered external thread and the bidirectional tapered hole of the bidirectional tapered internal thread. If oil and other media exist between the internal thread and the external thread for lubrication, a bearing oil film will be easily formed; and the clearance is beneficial to the formation of the bearing oil film. The asymmetric bidirectional tapered thread connection pair applied to transmission connection is equivalent to a set of sliding bearing pairs composed of one and/or several pairs of sliding bearings, i.e., each pitch of bidirectional tapered internal thread bidirectionally contains a corresponding pitch of bidirectional tapered external thread to form a pair of sliding bearings. When the whole asymmetric bidirectional tapered thread connection pair is applied to transmission connection, the number of sliding bearings is adjusted according to application conditions. Namely, the number of the effective bidirectional jointed, i.e., the effective bidirectional contact fitted, containing and contained thread pitches of the bidirectional tapered internal thread and the bidirectional tapered external thread is designed according to the application conditions. The multidirectional positioning of the internal cone body and the external cone body is formed through the bidirectional containment of the truncated cone body of the bidirectional tapered external thread by the tapered hole of the bidirectional tapered internal thread and the positioning in multiple directions such as radial, axial, angular and circumferential directions, preferably through the containment of the bidirectional truncated cone body by the bidirectional tapered hole and the main positioning in the radial and circumferential directions supplemented by the auxiliary positioning in the axial and angular directions, till the conical surface of the bidirectional tapered hole is fitted with the conical surface of the bidirectional truncated cone body to implement self-positioning or till the sizing interference contact is achieved to generate self-locking, which constitutes a special synthesis technology of the cone pair and the thread pair to ensure the precision, efficiency and reliability of the tapered thread technology, particularly the transmission connection of the asymmetric bidirectional tapered thread connection pair.

When the bidirectional tapered thread connection pair is used for fastening connection and sealing connection, the technical performances such as connection performance, locking performance, anti-loosening performance, bearing performance and sealing performance are realized through the screwing connection of the bidirectional tapered hole and the bidirectional truncated cone body, i.e., are realized through the sizing of the first helical conical surface of the truncated cone body and the first helical conical surface of the tapered hole till interference and/or the sizing of the second helical conical surface of the truncated cone body and the second helical conical surface of the tapered hole till interference and/or the sizing of the first helical conical surface of the truncated cone body and the second helical conical surface of the tapered hole till interference and/or the sizing of the second helical conical surface of the truncated cone body and the first helical conical surface of the tapered hole till interference. The load is borne in one direction and/or respectively borne in two directions at the same time according to the application conditions, i.e., the bidirectional truncated cone body and the bidirectional tapered hole are guided by the helical line to align the inner diameter and the outer diameter of the internal cone and the external cone till the second helical conical surface of the tapered hole is adhered with the first helical conical surface of the truncated cone body to bear sizing fit in one direction or two directions at the same time or till the sizing interference contact is achieved, and/or the second helical conical surface of the tapered hole is fitted with the second helical conical surface of the truncated cone body to bear sizing fit in one direction or two directions at the same time or till the sizing interference contact is achieved, and/or the second helical conical surface of the tapered hole is fitted with the first helical conical surface of the truncated cone body to bear sizing fit in one direction or two directions at the same time or till the sizing interference contact is achieved, and/or the first helical conical surface of the tapered hole is fitted with the second helical conical surface of the truncated cone body to bear sizing fit in one direction or two directions at the same time or till the sizing interference contact is achieved. The multidirectional positioning of the internal cone body and the external cone body is formed through the bidirectional containment of the bidirectional external cone by the bidirectional internal cone and the positioning in multiple directions such as radial, axial, angular and circumferential directions, preferably through the containment of the bidirectional truncated cone body by the bidirectional tapered hole and the main positioning in the radial and circumferential directions supplemented by the auxiliary positioning in the axial and angular directions, till the conical surface of the bidirectional tapered hole is fitted with the conical surface of the bidirectional truncated cone body to implement self-positioning or till the sizing interference contact is achieved to generate self-locking, which constitutes a special synthesis technology of the cone pair and the thread pair to realize the technical performances of a mechanical fastening mechanism, such as the connection performance, the locking performance, the anti-loosening performance, the bearing performance and the sealing performance.

Therefore, the technical performances such as the transmission precision and efficiency, the load bearing capacity, the locking force of self-locking, the anti-loosening ability and the sealing performance of the mechanical fastening mechanism using the asymmetric bidirectional tapered thread connection pair are related to the sizes of the first helical conical surface of the truncated cone body and the formed left taper, i.e., the corresponding first taper angle α1, the second helical conical surface of the truncated cone body and the formed right taper, i.e., the corresponding second taper angle α2, the first helical conical surface of the tapered hole and the formed left taper, i.e., the corresponding first taper angle α1, as well as the second helical conical surface of the tapered hole and the formed right taper, i.e., the corresponding second taper angle α2.

In other words, the self-locking and self-positioning ability of cone fit cannot be achieved at any taper angle or any taper. Namely, the technical performances such as the locking performance, the anti-loosening performance, the bearing performance and the sealing performance of the asymmetric bidirectional tapered thread connection pair mainly depend on the first helical conical surfaces of the internal thread and the external thread of the asymmetric bidirectional tapered thread and the formed left taper, i.e., the corresponding first taper angle, the second helical conical surfaces of the internal thread and the external thread and the formed right taper, i.e., the corresponding second taper angle. Material friction coefficient, processing quality and application conditions of the columnar body and the cylindrical body also have a certain impact on the technical performances.

In the asymmetric bidirectional tapered thread connection pair, when the right-angled trapezoid union rotates a circle at a constant speed, the axial movement distance of the right-angled trapezoid union is at least double the length of the sum of the right-angled sides of two right-angled trapezoids with the same lower bottom sides and upper sides and different right-angled sides. The structure ensures that the first helical conical surface and the second helical conical surface of the truncated cone body as well as the first helical conical surface and the second helical conical surface of the tapered hole have sufficient length, thereby ensuring that the conical surface of the bidirectional truncated cone body and the conical surface of the bidirectional tapered hole have sufficient effective contact area and strength and the efficiency required by helical movement during fitting.

In the asymmetric bidirectional tapered thread connection pair, when the right-angled trapezoid union rotates a circle at a constant speed, the axial movement distance of the right-angled trapezoid union is equal to the length of the sum of the right-angled sides of two right-angled trapezoids with the same lower bottom sides and upper sides and different right-angled sides. The structure ensures that the first helical conical surface of the truncated cone body and the second helical conical surface of the truncated cone body as well as the first helical conical surface of the tapered hole and the second helical conical surface of the tapered hole have sufficient length, thereby ensuring that the conical surface of the bidirectional truncated cone body and the conical surface of the bidirectional tapered hole have sufficient effective contact area and strength and the efficiency required by helical movement during fitting.

In the asymmetric bidirectional tapered thread connection pair, the first helical conical surface of the truncated cone body and the second helical conical surface of the truncated cone body are both continuous helical surfaces or discontinuous helical surfaces; and the first helical conical surface of the tapered hole and the second helical conical surface of the tapered hole are both continuous helical surfaces or discontinuous helical surfaces. Preferably, the first helical conical surface of the truncated cone body and the second helical conical surface of the truncated cone body as well as the first helical conical surface of the tapered hole and the second helical conical surface of the tapered hole are all continuous helical surfaces.

In the asymmetric bidirectional tapered thread connection pair, when the cylindrical body connecting hole is screwed into a screwing end of the columnar body, the screwing direction is regulated, i.e., the cylindrical body connecting hole cannot be reversely screwed. The taper directions corresponding to the angle formed between the two plain lines of the first helical conical surface of the internal thread and/or the external thread, i.e., the angle formed between the two plain lines of the second helical conical surface of the internal thread and/or the external thread, i.e., the second taper angle are reverse and/or opposite.

In the asymmetric bidirectional tapered thread connection pair, a head with the size greater than an outer diameter of the columnar body is arranged at one end of the columnar body, and/or a head with the size smaller than a minor diameter of the bidirectional tapered external thread of the columnar body is arranged at one end and/or two ends of the columnar body. The connecting hole is a threaded hole formed in a nut. Namely, the columnar body connected with the head is a bolt; and the columnar body having no head and/or having heads at both ends smaller than the minor diameter of the bidirectional tapered external thread and/or having no thread at the middle and having the bidirectional tapered external threads at both ends is a stud. The connecting hole is formed in the nut.

Compared with the prior art, the asymmetric bidirectional tapered thread connection pair has the advantages of reasonable design, simple structure, convenient operation, large locking force, high bearing capacity, excellent anti-loosening performance, high transmission efficiency and precision, good mechanical sealing effect and good stability, realizes the fastening and connecting functions through bidirectional bearing or sizing of the cone pair formed by coaxially aligning the inner diameter and the outer diameter of the internal cone and the external cone to achieve interference fit, can prevent loosening phenomenon during connection, and has self-locking and self-positioning functions.

### DESCRIPTION OF THE DRAWINGS

FIG. 1 is a structural schematic diagram of a thread connection pair composed of an olive-like (a left taper is smaller than a right taper) asymmetric bidirectional tapered external thread and a dumbbell-like (the left taper is greater than the right taper) asymmetric bidirectional tapered internal thread according to an embodiment 1 of the present disclosure;

FIG. 2 is a structural schematic diagram of an external thread of the olive-like (the left taper is smaller than the right taper) asymmetric bidirectional tapered thread and a complete unit thread thereof according to the embodiment 1 of the present disclosure;

FIG. 3 is a structural schematic diagram of an internal thread of the dumbbell-like (the left taper is greater than the right taper) asymmetric bidirectional tapered thread and a complete unit thread according to the embodiment 1 of the present disclosure;

FIG. 4 is a structural schematic diagram of a thread connection pair composed of a dumbbell-like (the left taper is greater than the right taper) asymmetric bidirectional tapered external thread and an olive-like (the left taper is smaller than the right taper) asymmetric bidirectional tapered internal thread according to an embodiment 2 of the present disclosure;

FIG. 5 is a structural schematic diagram of an external thread of the dumbbell-like (the left taper is greater than the right taper) asymmetric bidirectional tapered thread and a complete unit thread thereof according to the embodiment 2 of the present disclosure;

FIG. 6 is a structural schematic diagram of an internal thread of the olive-like (the left taper is smaller than the right taper) asymmetric bidirectional tapered thread and a complete unit thread according to the embodiment 2 of the present disclosure;

FIG. 7 is a graphic presentation of “the thread of the existing thread technology is an inclined plane on a cylindrical or conical surface” involved in the background of the present disclosure;

FIG. 8 is a graphic presentation of “an inclined plane slider model of the principle of the existing thread technology—the principle of inclined plane” involved in the background of the present disclosure; and

FIG. 9 is a graphic presentation of “a thread rise angle of the existing thread technology” involved in the background of the present disclosure.

In the figures, tapered thread 1, cylindrical body 2, nut body 21, columnar body 3, screw body 31, tapered hole 4, bidirectional tapered hole 41, conical surface 42 of the bidirectional tapered hole, first helical conical surface 421 of the tapered hole, first taper angle α1, second helical conical surface 422 of the tapered hole, second taper angle α2, internal helical line 5, internal thread 6, truncated cone body 7, bidirectional truncated cone body 71, conical surface 72 of the bidirectional truncated cone body, first helical conical surface 721 of the truncated cone body, first taper angle α1, second helical conical surface 722 of the truncated cone body, second taper angle α2, external helical line 8, external thread 9, olive-like shape 93, dumbbell-like shape 94, left taper 95, right taper 96, left-direction distribution 97, right-direction distribution 98, thread connection pair and/or thread pair 10, clearance 101, cone axis 01, thread axis 02, slider A on the inclined surface, inclined surface B, gravity G, gravity component G1 along the inclined plane, friction force F, thread rise angle φ, equivalent friction angle P, major diameter d of the traditional external thread, minor diameter d1 of the traditional external thread and pitch diameter d2 of the traditional external thread.

### DETAILED DESCRIPTION OF PREFERRED EMBODIMENTS

The present disclosure will be further described in detail below with reference to the accompany drawings and specific embodiments.

### Embodiment 1

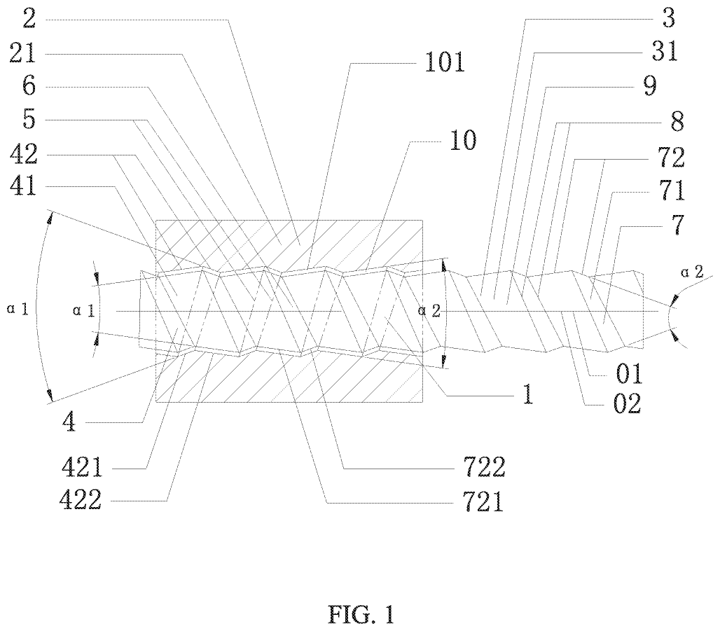

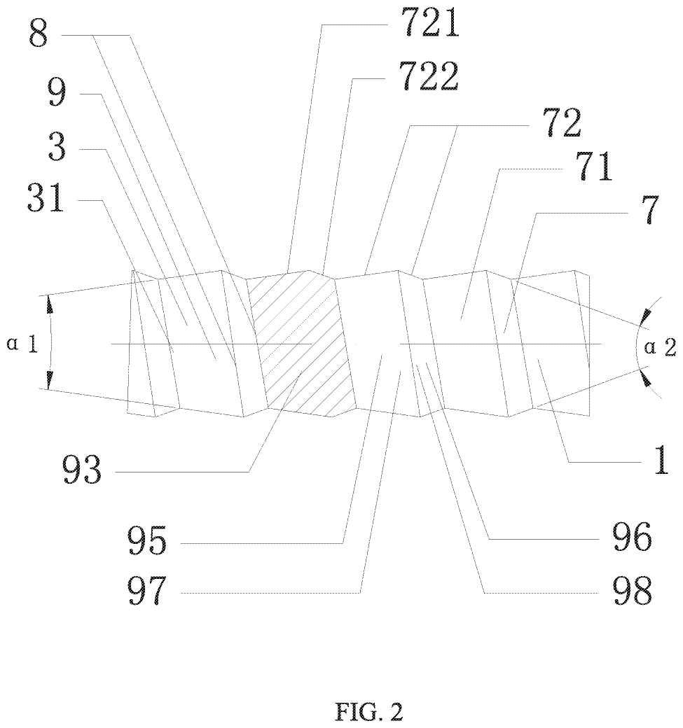

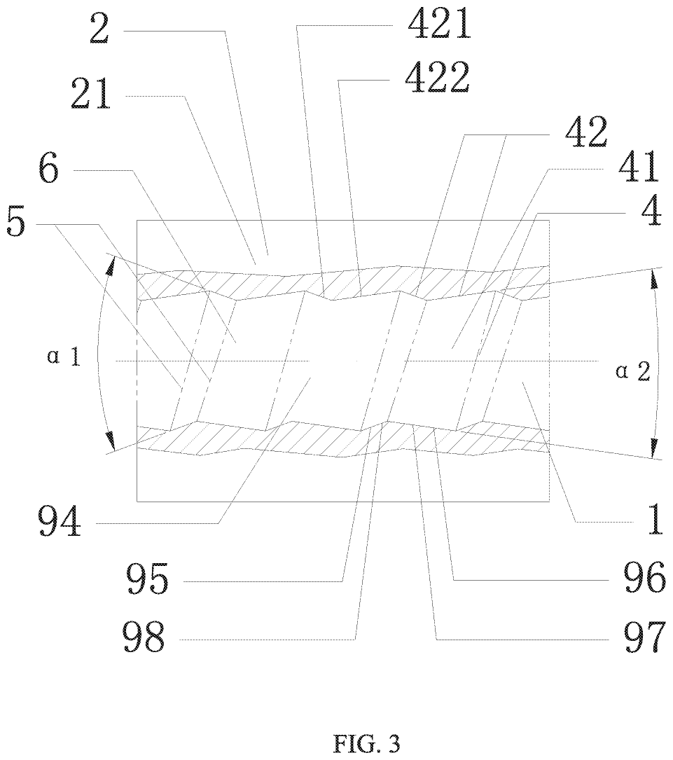

As shown in FIGS. 1, 2 and 3, an asymmetric bidirectional tapered thread connection pair 10 comprises a bidirectional truncated cone body 71 helically distributed on an outer surface of a columnar body 3 and a bidirectional tapered hole 41 helically distributed in an inner surface of a cylindrical body 2, namely, comprises an external thread 9 and an internal thread 6 which are in threaded fitting with each other. The internal thread 6 is distributed as a helical bidirectional tapered hole 41; and the external thread 9 is distributed as a helical bidirectional truncated cone body 71. The internal thread 6 exists in the form of helical bidirectional tapered hole 41 (non-entity space); and the external thread 9 exists in the form of helical bidirectional truncated cone body 71 (material entity). The internal thread 6 and the external thread 9 are subjected to a relationship of containing part and contained part. The threads work in such a state that the internal thread 6 and the external thread 9 are fitted together by screwing bidirectional tapered geometries pitch by pitch till interference fit is achieved, i.e., the bidirectional tapered hole 41 contains the bidirectional truncated cone body 71 pitch by pitch, i.e., the internal thread 6 contains the external thread 9 pitch by pitch. The bidirectional containment limits the disordered degree of freedom between the tapered hole 4 and the truncated cone body 7; the helical movement enables the asymmetric bidirectional tapered thread connection pair 10 to obtain the necessary ordered degree of freedom, thereby effectively synthesizing the technical characteristics of the cone pair and the thread pair.

When the asymmetric bidirectional tapered thread connection pair 10 in the present embodiment is used, a conical surface 72 of the bidirectional truncated cone body and the conical surface 42 of the bidirectional tapered hole are fitted with each other.

The asymmetric bidirectional tapered thread connection pair 10 in the present embodiment has the self-locking and self-positioning performances only if the truncated cone body 7 of a bidirectional tapered thread 1 and/or the tapered hole 4 reaches a certain taper, i.e., cone bodies forming the cone pair reach a certain taper angle. The taper comprises a left taper 95 and a right taper 96, i.e., the taper angle comprises a left taper angle and a right taper angle. In the present embodiment, the asymmetric bidirectional tapered external thread 9 is of an olive-like shape 93 and has the left taper 95 smaller than the right taper 96; and the asymmetric bidirectional tapered internal thread 6 is of a dumbbell-like shape 94 and has the left taper 95 greater than the right taper 96. The left taper 95 corresponds to the left taper angle, i.e., a first taper angle α1; and the right taper 96 corresponds to the right taper angle, i.e., a second taper angle α2.

When the left taper 95 is greater than the right taper 96, it is preferable that the first taper angle α1 is greater than 0° and smaller than 53°; and preferably, the first taper angle α1 is 2°-40°. In individual special fields, it is preferable that the first taper angle α1 is greater than or equal to 53° and smaller than 180°; and preferably, the first taper angle α1 is 53°-90°. It is preferable that the second taper angle α2 is greater than 0° and smaller than 53°; and preferably, the second taper angle α2 is 2°-40°.

When the left taper 95 is smaller than the right taper 96, it is preferable that the first taper angle α1 is greater than 0° and smaller than 53°; and preferably, the first taper angle α1 is 2°-40°. It is preferable that the second taper angle α2 is greater than 0° and smaller than 53°; and preferably, the second taper angle α2 is 2°-40°. In individual special fields, it is preferable that the second taper angle α2 is greater than or equal to 53° and smaller than 180°; and preferably, the second taper angle α2 is 53°-90°.

The above-mentioned individual special fields refer to the application fields of thread connection such as transmission connection with low requirements on self-locking performance or even without self-locking performance and/or with low requirements on self-positioning performance and/or with high requirements on axial bearing capacity and/or with indispensable anti-locking measures.

The external thread 9 is arranged on the outer surface of the columnar body 3. The columnar body 3 is provided with a screw body 31; the truncated cone body 7 is helically distributed on the outer surface of the screw body 31; and the truncated cone body 7 comprises the asymmetric bidirectional truncated cone body 71, which is a special bidirectional tapered geometry in the olive-like shape 93 and the left taper 95 smaller than the right taper 96. The columnar body 3 may be solid or hollow, comprising cylinders, cones, tubes and the like.

The asymmetric bidirectional truncated cone body 71 in the olive-like shape 93 is formed by symmetrically and oppositely jointing lower bottom surfaces of two truncated cone bodies with the same lower bottom surfaces and upper top surfaces and different cone heights. Namely, when the lower bottom surfaces of two truncated cone bodies with the same lower bottom surfaces and upper top surfaces and different cone heights are jointed with each other, and the upper top surfaces are located at both ends of the bidirectional truncated cone body 71 to form the asymmetric bidirectional tapered thread 1, the process comprises that the lower bottom surfaces are respectively jointed with the upper top surfaces of the adjacent bidirectional truncated cone bodies 71 and/or to be respectively jointed with the upper top surfaces of the adjacent bidirectional truncated cone bodies 71. The outer surface of the truncated cone body 7 comprises the conical surface 72 of the asymmetric bidirectional truncated cone body. The external thread 9 comprises a first helical conical surface 721 of the truncated cone body, a second helical conical surface 722 of the truncated cone body and an external helical line 8, which form an asymmetric bidirectional tapered external thread 9. In the cross section through which the thread axis passes through, a complete single-pitch asymmetric bidirectional tapered external thread 9 is a special bidirectional tapered geometry in the olive-like shape 93 and with a large middle and two small ends. The angle formed between two plain lines of the left conical surface of the asymmetric bidirectional truncated cone body 71, i.e., the first helical conical surface 721 of the truncated cone body, is the first taper angle α1, i.e., the left taper angle corresponding to the left taper 95 of the external thread 9 of the asymmetric bidirectional tapered thread. The left taper 95 is subjected to a left-direction distribution 97. The angle formed between the two plain lines of the right conical surface of the asymmetric bidirectional truncated cone body 71, i.e., the second helical conical surface 722 of the truncated cone body, is the second taper angle α2, i.e., the right taper angle corresponding to the right taper 96 of the external thread 9 of the asymmetric bidirectional tapered thread. The right taper 96 is subjected to a right-direction distribution 98. The taper directions corresponding to the first taper angle α1 and the second taper angle α2 are opposite. The plain line is an intersection line of the conical surface and the plane through which the cone axis passes through. The shape formed by the first helical conical surface 721 and the second helical conical surface 722 of the truncated cone body of the bidirectional truncated cone body 71 is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the columnar body 3. The right-angled side is coincident with the central axis of the columnar body 3; and the right-angled trapezoid union is formed by symmetrically and oppositely jointing lower bottom sides of two right-angled trapezoids with the same lower bottom sides and upper sides and different right-angled sides. The right-angled trapezoid union refers to a special geometry, which is formed by symmetrically and oppositely jointing the lower bottom sides of two right-angled trapezoids with the same lower bottom sides and upper sides and different right-angled sides and has the upper sides respectively located at both ends of the right-angled trapezoid union. The left taper 95 is formed by the first helical conical surface 721 of the truncated cone body and corresponds to the first taper angle α1 of the asymmetric bidirectional tapered external thread 9, i.e., the left taper angle corresponding to the left taper 95 of the external thread 9 of the asymmetric bidirectional tapered thread. The left taper 95 is subjected to the left-direction distribution 97. The right taper 96 is formed by the second helical conical surface 722 of the truncated cone body and corresponds to the second taper angle α2 of the asymmetric bidirectional tapered external thread 9, i.e., the right taper angle corresponding to the right taper 96 of the external thread 9 of the asymmetric bidirectional tapered thread. The right taper 96 is subjected to the right-direction distribution 98. The taper directions corresponding to the first taper angle α1 and the second taper angle α2 are opposite.

The internal thread 6 is arranged on the inner surface of the cylindrical body 2. The cylindrical body 2 is provided with a nut body 21; and the tapered hole 4 is helically distributed in the inner surface of the nut body 21, comprising the asymmetric bidirectional tapered hole 41. The asymmetric bidirectional tapered hole 41 is a special bidirectional tapered geometry in the dumbbell-like shape 94 and with the left taper 95 greater than the right taper 96. The cylindrical body 2 comprises cylindrical and/or non-cylindrical workpieces and objects which need to be machined with the internal threads on the inner surfaces.

The asymmetric bidirectional tapered hole 41 in the dumbbell-like shape 94 is formed by symmetrically and oppositely jointing upper top surfaces of two tapered holes with the same lower bottom surfaces and upper top surfaces and different cone heights. Namely, when the upper top surfaces of two tapered holes with the same lower bottom surfaces and upper top surfaces and different cone heights are jointed with each other, and the lower bottom surfaces are located at both ends of the bidirectional tapered hole 41 to form the asymmetric bidirectional tapered thread 1, the process comprises that the upper top surfaces are respectively jointed with the lower bottom surfaces of the adjacent bidirectional tapered holes 41 and/or to be respectively jointed with the lower bottom surfaces of the adjacent bidirectional tapered holes 41. The tapered hole 4 comprises the conical surface 42 of the asymmetric bidirectional tapered hole. The internal thread 6 comprises the first helical conical surface 421 of the tapered hole, the second helical conical surface 422 of the tapered hole and the internal helical line 5, which form the asymmetric bidirectional tapered internal thread 6. In the cross section through which the thread axis passes through, the complete single-pitch asymmetric bidirectional tapered internal thread 6 is a special bidirectional tapered geometry in the dumbbell-like shape 94 and with a small middle and two large ends. The angle formed by the two plain lines of the left conical surface of the bidirectional tapered hole 41, i.e., the first helical conical surface 421 of the tapered hole, is the first taper angle α1, i.e., the left taper angle corresponding to the left taper 95 of the internal thread 6 of the asymmetric bidirectional tapered thread. The left taper 95 is subjected to the right-direction distribution 98. The angle formed by the two plain lines of the right conical surface of the bidirectional tapered hole 41, i.e., the second helical conical surface 422 of the tapered hole, is the second taper angle α2, i.e., the right taper angle corresponding to the right taper 96 of the internal thread 6 of the asymmetric bidirectional tapered thread. The right taper 96 is subjected to the left-direction distribution 97. The taper directions corresponding to the first taper angle α1 and the second taper angle α2 are opposite. The plain line is an intersection line of the conical surface and the plane through which the cone axis passes through. The shape formed by the first helical conical surface 421 and the second helical conical surface 422 of the tapered hole of the bidirectional tapered hole 41 is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body 2. The right-angled side is coincident with the central axis of the cylindrical body 2; and the right-angled trapezoid union is formed by symmetrically and oppositely jointing upper sides of two right-angled trapezoids with the same lower bottom sides and upper sides and different right-angled sides. The right-angled trapezoid union refers to a special geometry, which is formed by symmetrically and oppositely jointing the upper sides of two right-angled trapezoids with the same lower bottom sides and upper sides and different right-angled sides and has the lower bottom sides respectively located at both ends of the right-angled trapezoid union. The left taper 95 is formed by the first helical conical surface 421 of the tapered hole and corresponds to the first taper angle α1 of the asymmetric bidirectional tapered internal thread 6, i.e., the left taper angle corresponding to the left taper 95 of the internal thread 6 of the asymmetric bidirectional tapered thread. The left taper 95 is subjected to the right-direction distribution 98. The right taper 96 is formed by the second helical conical surface 422 of the tapered hole and corresponds to the second taper angle α2 of the asymmetric bidirectional tapered internal thread 6, i.e., the right taper angle corresponding to the right taper 96 of the internal thread 6 of the asymmetric bidirectional tapered thread. The right taper 96 is subjected to the left-direction distribution 97. The taper directions corresponding to the first taper angle α1 and the second taper angle α2 are opposite.

When the asymmetric bidirectional tapered thread connection pair 10 in the present embodiment is used for transmission connection, the bidirectional bearing is implemented through the screwing connection between the bidirectional tapered hole 41 and the bidirectional truncated cone body 71. When the external thread 9 and the internal thread 6 form the thread pair 10, a clearance 101 must be reserved between the internal thread 6 and the external thread 9, i.e., the clearance 101 must be reserved between the bidirectional truncated cone body 71 and the bidirectional tapered hole 41. If oil and other media exist between the internal thread 6 and the external thread 9 for lubrication, a bearing oil film will be easily formed; and the clearance 101 is beneficial to the formation of the bearing oil film. The asymmetric bidirectional tapered thread connection pair 10 is equivalent to a set of sliding bearing pairs composed of one and/or several pairs of sliding bearings, i.e., each pitch of bidirectional tapered internal thread 6 bidirectionally contains a corresponding pitch of bidirectional tapered external thread 9 to form a pair of sliding bearings. The whole asymmetric bidirectional tapered thread connection pair 10 applied to transmission connection is composed of one or several pairs of sliding bearings. The number of sliding bearings is adjusted according to application conditions. Namely, the number of the effective jointed containing and contained thread pitches of the bidirectional tapered internal thread 6 and the bidirectional tapered external thread 9 is designed according to the application conditions. A special synthesis technology of the cone pair and the thread pair is constituted through the containment of the bidirectional external cone 9 by the bidirectional internal cone 6 and the positioning in multiple directions such as radial, axial, angular and circumferential directions, to ensure the precision, efficiency and reliability of the tapered thread technology, particularly the transmission connection of the asymmetric bidirectional tapered thread connection pair 10.

When the asymmetric bidirectional tapered thread connection pair 10 is used for fastening connection and sealing connection, the technical performances such as connection performance, locking performance, anti-loosening performance, bearing performance and sealing performance are realized through the screwing connection of the bidirectional tapered hole 41 and the bidirectional truncated cone body 71. The load is borne in one direction and/or respectively borne in two directions at the same time according to the application conditions, i.e., the bidirectional truncated cone body 71 and the bidirectional tapered hole 41 are guided by the helical line to align the inner diameter and the outer diameter of the internal cone and the external cone till the first helical conical surface 421 of the tapered hole is adhered with the second helical conical surface 722 of the truncated cone body to achieve interference contact and/or till the second helical conical surface 422 of the tapered hole is fitted with the first helical conical surface 721 of the truncated cone body to achieve interference contact, thereby realizing the technical performances of a mechanical fastening mechanism, such as the connection performance, the locking performance, the anti-loosening performance, the bearing performance and the sealing performance.

Therefore, the technical performances such as the transmission precision, the transmission efficiency, the load bearing capacity, the locking force of self-locking, the anti-loosening ability, the sealing performance and reusability of the mechanical fastening mechanism using the asymmetric bidirectional tapered thread connection pair 10 in the present embodiment are related to the sizes of the first helical conical surface 721 of the truncated cone body and the formed left taper 95, i.e., the corresponding first taper angle α1, the second helical conical surface 722 of the truncated cone body and the formed right taper 96, i.e., the corresponding second taper angle α2, the first helical conical surface 421 of the tapered hole and the formed left taper 95, i.e., the corresponding first taper angle α1, as well as the second helical conical surface 422 of the tapered hole and the formed right taper 96, i.e., the corresponding second taper angle α2.

In other words, the self-locking and self-positioning ability of cone fit cannot be achieved at any taper angle or any taper. Namely, the technical performances such as the locking performance, the anti-loosening performance, the bearing performance, the transmission performance and the sealing performance of the asymmetric bidirectional tapered thread connection pair 10 mainly depend on the first helical conical surfaces of the internal thread 6 and the external thread 9 of the asymmetric bidirectional tapered thread 1 and the formed left taper 95, i.e., the corresponding first taper angle α1, the second helical conical surfaces of the internal thread 6 and the external thread 9 and the formed right taper 96, i.e., the corresponding second taper angle α2. Material friction coefficient, processing quality and application conditions of the columnar body 3 and the cylindrical body 2 also have a certain impact on the technical performances.

In the asymmetric bidirectional tapered thread connection pair 10, when the right-angled trapezoid union rotates a circle at a constant speed, the axial movement distance of the right-angled trapezoid union is at least double the length of the sum of the right-angled sides of two right-angled trapezoids with the same lower bottom sides and upper sides and different right-angled sides. The structure ensures that the first helical conical surface 721 and the second helical conical surface 722 of the truncated cone body as well as the first helical conical surface 421 and the second helical conical surface 422 of the tapered hole have sufficient length, thereby ensuring that the conical surface 72 of the bidirectional truncated cone body and the conical surface 42 of the bidirectional tapered hole have sufficient effective contact area and strength and the efficiency required by helical movement during fitting.

In the asymmetric bidirectional tapered thread connection pair 10, when the right-angled trapezoid union rotates a circle at a constant speed, the axial movement distance of the right-angled trapezoid union is equal to the length of the sum of the right-angled sides of two right-angled trapezoids with the same lower bottom sides and upper sides and different right-angled sides. The structure ensures that the first helical conical surface 721 and the second helical conical surface 722 of the truncated cone body as well as the first helical conical surface 421 and the second helical conical surface 422 of the tapered hole have sufficient length, thereby ensuring that the conical surface 72 of the bidirectional truncated cone body and the conical surface 42 of the bidirectional tapered hole have sufficient effective contact area and strength and the efficiency required by helical movement during fitting.

In the asymmetric bidirectional tapered thread connection pair 10, the first helical conical surface 721 of the truncated cone body and the second helical conical surface 722 of the truncated cone body are both continuous helical surfaces or discontinuous helical surfaces; and the first helical conical surface 421 of the tapered hole and the second helical conical surface 422 of the tapered hole are both continuous helical surfaces or discontinuous helical surfaces. Preferably, the first helical conical surface 721 of the truncated cone body and the second helical conical surface 722 of the truncated cone body as well as the first helical conical surface 421 of the tapered hole and the second helical conical surface 422 of the tapered hole are all continuous helical surfaces.

In the asymmetric bidirectional tapered thread connection pair 10, when the cylindrical body 2 connecting hole is screwed into a screwing end of the columnar body 3, the screwing direction is regulated, i.e., the cylindrical body 2 connecting hole cannot be reversely screwed. The contact surfaces between the first helical conical surface 721 of the truncated cone body and the second helical conical surface 422 of the tapered hole serve as bearing surfaces and/or interference fit, and/or the contact surfaces between the second helical conical surface 722 of the truncated cone body and the first helical conical surface 421 of the tapered hole serve as bearing surfaces and/or interference fit, and/or the first helical conical surface 421 and the second helical conical surface 422 of the tapered hole are in containing cohesion contact with the first helical conical surface 721 and the second helical conical surface 722 of the truncated cone body. A connecting function of the asymmetric bidirectional tapered thread connection pair 10 is realized through the containing cohesion contact and/or interference fit between the conical surfaces of the internal thread 6 and the external thread 9.

In the asymmetric bidirectional tapered thread connection pair 10, a head with the size greater than an outer diameter of the columnar body 3 is arranged at one end of the columnar body 3, and/or a head with the size smaller than a minor diameter of the tapered external thread 9 of a screw body 31 of the columnar body 3 is arranged at one end and/or two ends of the columnar body 3. The connecting hole is a threaded hole formed in a nut body 21. Namely, the columnar body 3 connected with the head is a bolt; and the columnar body having no head and/or having heads at both ends smaller than the minor diameter of the bidirectional tapered external thread 9 and/or having no thread at the middle and having the bidirectional tapered external threads 9 at both ends is a stud. The connecting hole is formed in the nut body 21.

Compared with the prior art, the asymmetric bidirectional tapered thread connection pair 10 has the advantages of reasonable design, simple structure, convenient operation, large locking force, high bearing capacity, excellent anti-loosening performance, high transmission efficiency and precision, good mechanical sealing effect and good stability, realizes the fastening and connecting functions through sizing of the cone pair formed by the internal cone and the external cone to achieve interference fit, can prevent loosening phenomenon during connection, and has self-locking and self-positioning functions.

### Embodiment 2

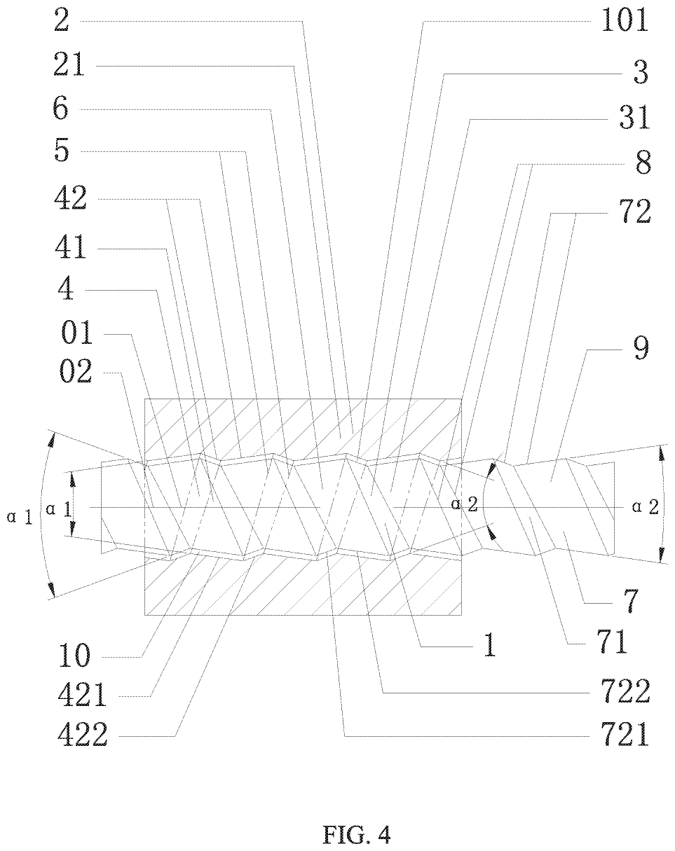

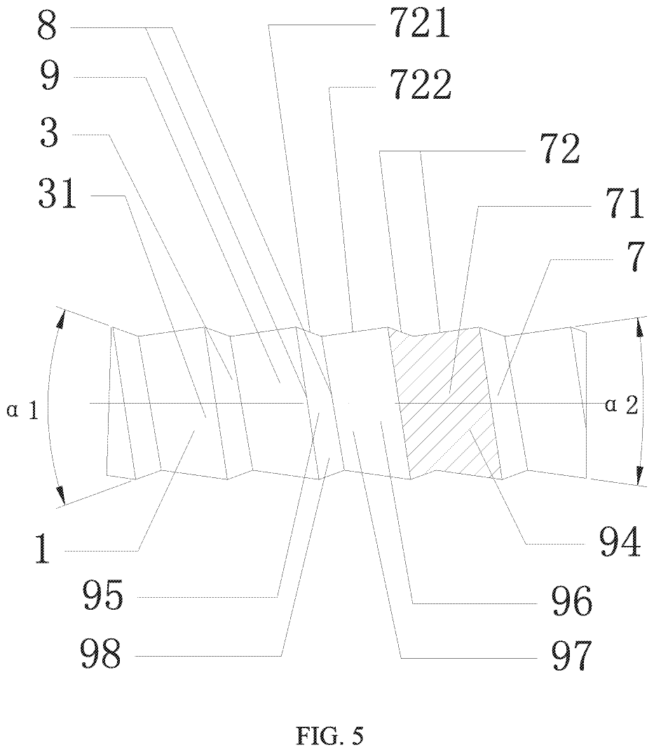

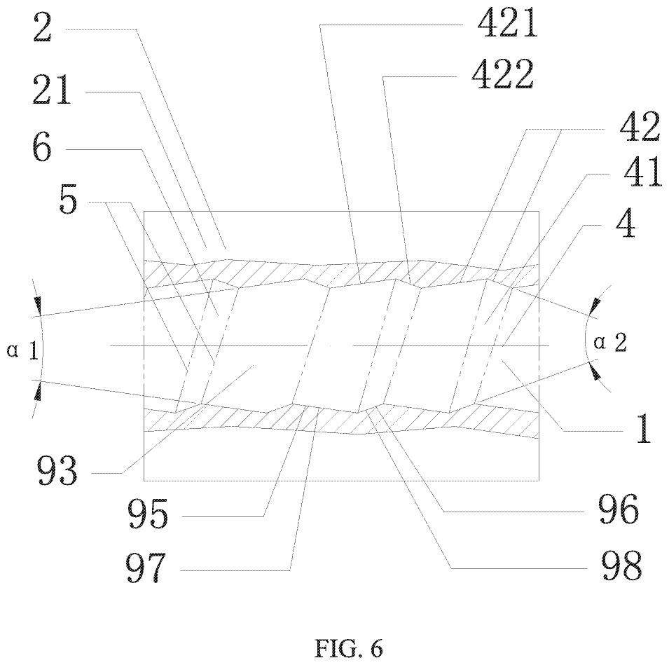

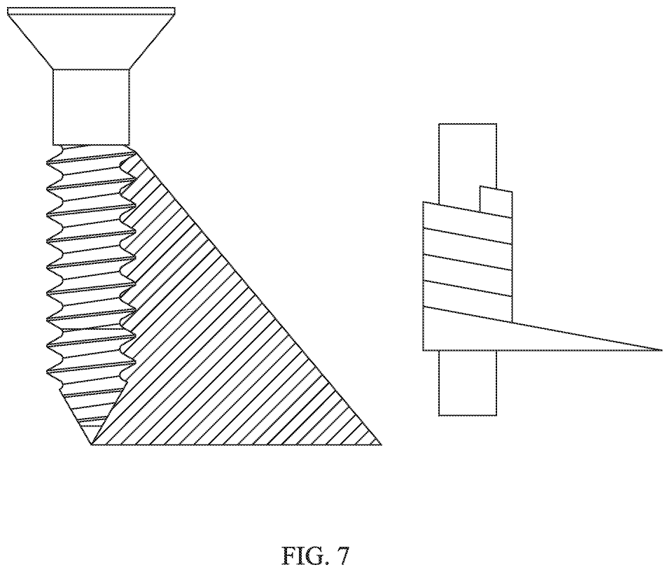

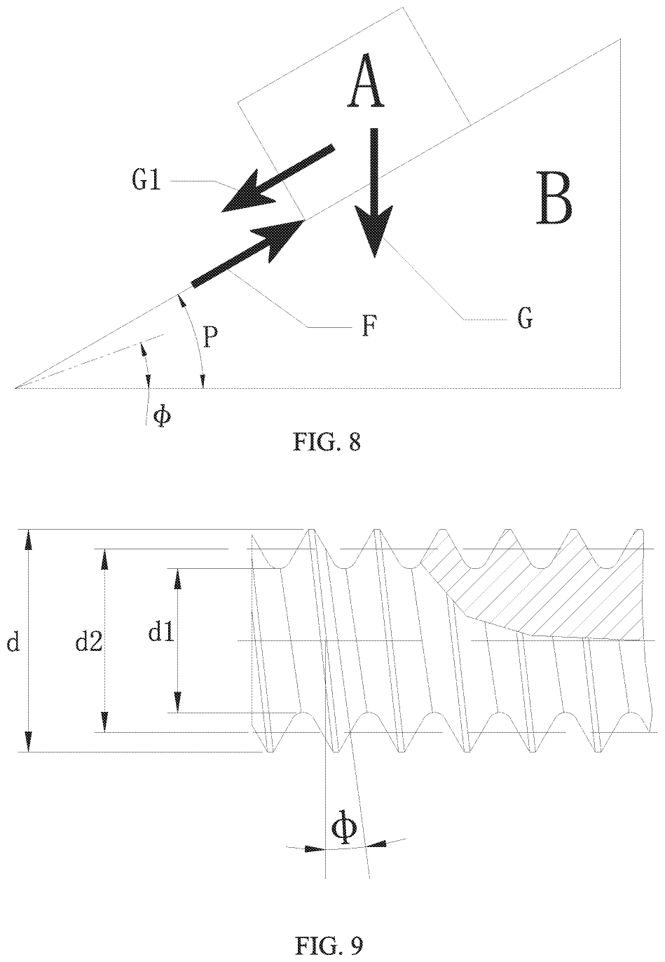

As shown in FIGS. 4, 5 and 6, the structures, principles and implementation steps in the present embodiment are similar to those in the embodiment 1. The differences are that, in the present embodiment, the external thread 9 forming the thread pair 10 is the asymmetric bidirectional tapered thread 1 in the dumbbell-like shape 94, i.e., the asymmetric bidirectional truncated cone body 71 in the dumbbell-like shape 94 and with the left taper 95 greater than the right taper 96; and the internal thread 6 is the asymmetric bidirectional tapered thread 1 in the olive-like shape 93, i.e., the asymmetric bidirectional tapered hole 41 in the olive-like shape 93 and with the left taper 95 smaller than the right taper 96.

The asymmetric bidirectional truncated cone body 71 in the dumbbell-like shape 94 is formed by symmetrically and oppositely jointing the upper top surfaces of two truncated cone bodies with the same lower bottom surfaces and upper top surfaces and different cone heights. Namely, when the upper top surfaces of two truncated cone bodies with the same lower bottom surfaces and upper top surfaces and different cone heights are jointed with each other, and the lower bottom surfaces are located at both ends of the bidirectional truncated cone body 71 to form the asymmetric bidirectional tapered thread 1, the process comprises that the upper top surfaces are respectively jointed with the lower bottom surfaces of the adjacent bidirectional truncated cone bodies 71 and/or to be respectively jointed with the lower bottom surfaces of the adjacent bidirectional truncated cone bodies 71. The outer surface of the truncated cone body 7 is provided with the conical surface 72 of the asymmetric bidirectional truncated cone body. The external thread 9 comprises the first helical conical surface 721 of the truncated cone body, the second helical conical surface 722 of the truncated cone body and the external helical line 8, which form the asymmetric bidirectional tapered external thread 9. In the cross section through which the thread axis passes through, the complete single-pitch asymmetric bidirectional tapered external thread 9 is a special bidirectional tapered geometry in the dumbbell-like shape 94 and with a small middle and two large ends. The angle formed between the two plain lines of the left conical surface of the asymmetric bidirectional truncated cone body 71, i.e., the first helical conical surface 721 of the truncated cone body, is the first taper angle α1, i.e., the left taper angle corresponding to the left taper 95 of the external thread 9 of the asymmetric bidirectional tapered thread. The left taper 95 is subjected to a right-direction distribution 98. The angle formed by the two plain lines of the right conical surface of the asymmetric bidirectional truncated cone body 71, i.e., the second helical conical surface 722 of the truncated cone body, is the second taper angle α2, i.e., the right taper angle corresponding to the right taper 96 of the external thread 9 of the asymmetric bidirectional tapered thread. The right taper 96 is subjected to a left-direction distribution 97. The taper directions corresponding to the first taper angle α1 and the second taper angle α2 are opposite. The plain line is an intersection line of the conical surface and the plane through which the cone axis passes through. The shape formed by the first helical conical surface 721 and the second helical conical surface 722 of the truncated cone body of the bidirectional truncated cone body 71 is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the columnar body 3. The right-angled side is coincident with the central axis of the columnar body 3; and the right-angled trapezoid union is formed by symmetrically and oppositely jointing upper sides of two right-angled trapezoids with the same lower bottom sides and upper sides and different right-angled sides. The right-angled trapezoid union refers to a special geometry, which is formed by symmetrically and oppositely jointing the upper sides of two right-angled trapezoids with the same lower bottom sides and upper sides and different right-angled sides and has the lower bottom sides respectively located at both ends of the right-angled trapezoid union. The left taper 95 is formed by the first helical conical surface 721 of the truncated cone body and corresponds to the first taper angle α1 of the asymmetric bidirectional tapered external thread 9, i.e., the left taper 95 of the external thread 9 of the asymmetric bidirectional tapered thread corresponds to the left taper angle and is subjected to the right-direction distribution 98. The right taper 96 is formed by the second helical conical surface 722 of the truncated cone body and corresponds to the second taper angle α2 of the asymmetric bidirectional tapered external thread 9, i.e., the right taper 96 of the external thread 9 of the asymmetric bidirectional tapered thread corresponds to the right taper angle and is subjected to the left-direction distribution 97. The taper directions corresponding to the first taper angle α1 and the second taper angle α2 are opposite.

The asymmetric bidirectional tapered hole 41 in the olive-like shape 93 is formed by symmetrically and oppositely jointing lower bottom surfaces of two tapered holes with the same lower bottom surfaces and upper top surfaces and different cone heights. Namely, when the lower bottom surfaces of two tapered holes with the same lower bottom surfaces and upper top surfaces and different cone heights are jointed with each other, and the upper top surfaces are located at both ends of the bidirectional tapered hole 41 to form the asymmetric bidirectional tapered thread 1, the process comprises that the lower bottom surfaces are respectively jointed with the upper top surfaces of the adjacent bidirectional tapered holes 41 and/or to be respectively jointed with the upper top surfaces of the adjacent bidirectional tapered holes 41. The tapered hole 4 comprises the conical surface 42 of the asymmetric bidirectional tapered hole. The internal thread 6 comprises a first helical conical surface 421 of the tapered hole, a second helical conical surface 422 of the tapered hole and an internal helical line 5, which form an asymmetric bidirectional tapered internal thread 6. In the cross section through which the thread axis passes through, the complete single-pitch asymmetric bidirectional tapered internal thread 6 is a special bidirectional tapered geometry in the olive-like shape 93 and with a large middle and two small ends. The angle formed by the two plain lines of the left conical surface of the bidirectional tapered hole 41, i.e., the first helical conical surface 421 of the tapered hole, is the first taper angle α1, i.e., the left taper angle corresponding to the left taper 95 of the internal thread 6 of the asymmetric bidirectional tapered thread. The left taper 95 is subjected to the left-direction distribution 97. The angle formed by the two plain lines of the right conical surface of the bidirectional tapered hole 41, i.e., the second helical conical surface 422 of the tapered hole, is the second taper angle α2, i.e., the right taper angle corresponding to the right taper 96 of the internal thread 6 of the asymmetric bidirectional tapered thread. The right taper 96 is subjected to the right-direction distribution 98. The taper directions corresponding to the first taper angle α1 and the second taper angle α2 are opposite. The plain line is an intersection line of the conical surface and the plane through which the cone axis passes through. The shape formed by the first helical conical surface 421 and the second helical conical surface 422 of the tapered hole of the bidirectional tapered hole 41 is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body 2. The right-angled side is coincident with the central axis of the cylindrical body 2; and the right-angled trapezoid union is formed by symmetrically and oppositely jointing lower bottom sides of two right-angled trapezoids with the same lower bottom sides and upper sides and different right-angled sides. The right-angled trapezoid union refers to a special geometry, which is formed by symmetrically and oppositely jointing the lower bottom sides of two right-angled trapezoids with the same lower bottom sides and upper sides and different right-angled sides and has the upper sides respectively located at both ends of the right-angled trapezoid union. The left taper 95 is formed by the first helical conical surface 421 of the tapered hole and corresponds to the first taper angle α1 of the asymmetric bidirectional tapered internal thread 6, i.e., the left taper 95 of the internal thread 6 of the asymmetric bidirectional tapered thread corresponds to the left taper angle and is subjected to the left-direction distribution 97. The right taper 96 is formed by the second helical conical surface 422 of the tapered hole and corresponds to the second taper angle α2 of the asymmetric bidirectional tapered internal thread 6, i.e., the right taper 96 of the internal thread 6 of the asymmetric bidirectional tapered thread corresponds to the right taper angle and is subjected to the right-direction distribution 98. The taper directions corresponding to the first taper angle α1 and the second taper angle α2 are opposite.

The specific embodiments described herein are merely examples to illustrate the spirit of the present disclosure. Those skilled in the art of the present disclosure can make various modifications or supplements to the specific embodiments described or substitute with similar modes without deviating from the spirit of the present disclosure or going beyond the scope defined by the appended claims.

The terms such as tapered thread 1, cylindrical body 2, nut body 21, columnar body 3, screw body 31, tapered hole 4, bidirectional tapered hole 41, helical conical surface 42 of the bidirectional tapered hole, first helical conical surface 421 of the tapered hole, first taper angle α1, second helical conical surface 422 of the tapered hole, second taper angle α2, internal helical line 5, internal thread 6, truncated cone body 7, bidirectional truncated cone body 71, conical surface 72 of the bidirectional truncated cone body, first helical conical surface 721 of the truncated cone body, first taper angle α1, second helical conical surface 722 of the truncated cone body, second taper angle α2, external helical line 8, external thread 9, olive-like shape 93, dumbbell-like shape 94, left taper 95, right taper 96, left-direction distribution 97, right-direction distribution 98, thread connection pair and/or thread pair 10, clearance 101, self-locking force, self-locking, self-positioning, pressure, cone axis 01, thread axis 02, mirror image, shaft sleeve, shaft, non-entity space, material entity, single tapered body, double tapered body, cone body, internal cone body, tapered hole, external cone body, tapered body, cone pair, helical structure, helical movement, thread body, complete unit thread, axial force, axial force angle, counter-axial force, counter-axial force angle, centripetal force, counter-centripetal force, reversely collinear, internal stress, bidirectional force, unidirectional force, sliding bearing and sliding bearing pair are widely used, but the possibility of using other terms is not excluded. These terms are merely used to describe and explain the essence of the present disclosure more conveniently; and it is contrary to the spirit of the present disclosure to interpret the terms as any additional limitation.

We claim:

1. A dumbbell-like shaped and olive-like shaped asymmetric bidirectional tapered thread connection pair, comprising an external thread (9) and an internal thread (6) which are in mutual threaded fit;
wherein a complete unit thread of the asymmetric bidirectional tapered thread (1) comprises a bidirectional tapered body in an olive-like shape (93) and/or in a dumbbell-like shape (94);
the bidirectional tapered body comprises a bidirectional tapered hole (41) and/or a bidirectional truncated cone body (71); a thread body of the internal thread (6) is a cylindrical body (2) with a helical inner surface, comprises a bidirectional tapered hole in the olive-like shape (93) and/or in the dumbbell-like shape (94) and exists in the form of a non-entity space;
a thread body of the external thread (9) is a columnar body (3) with a helical outer surface, comprises a bidirectional truncated cone body (71) in the olive-like shape (93) and/or in the dumbbell-like shape (94) and exists in the form of a material entity; the left taper (95) formed by the left conical surface of the bidirectional tapered body corresponds to a first taper angle (α1), and the right taper (96) formed by the right conical surface corresponds to a second taper angle (α2);
the internal thread (6) and the external thread (9) contains the tapered body through the tapered hole until an inner conical surface and an outer conical surface bear each other.

2. The thread connection pair according to claim 1, wherein the bidirectional tapered internal thread (6) in the dumbbell-like shape (94) comprises a first helical conical surface (421) of the tapered hole, a second helical conical surface (422) of the tapered hole, and an internal helical line (5);
a first shape formed by the first helical conical surface (421) of the tapered hole and the second helical conical surface (422) of the tapered hole is the same as a shape of a helical outer flank of a second rotating body; wherein the second rotating body is formed by a second right-angled trapezoid union being rotated around a right-angled side of the second right-angled trapezoid union, and, at the same time, the second right-angled trapezoid union axially moves at a constant speed along the central axis of the cylindrical nut (2); wherein the second right-angled trapezoid union is formed by oppositely jointing two symmetrical upper sides of two right-angled trapezoids; wherein the two right-trapezoids have identical lower sides and upper sides, and same and/or different right-angled sides; wherein the two right-trapezoids are coincident with the central axis of the cylindrical nut (2);
the external thread (9) comprises a first helical conical surface (721) of the truncated cone body, a second helical conical surface (722) of the truncated cone body, and an external helical line (8);
a second shape formed by the first helical conical surface (721) of the truncated cone body and the second helical conical surface (722) of the truncated cone body, is the same as the shape of a helical outer flank of the second rotating body, wherein the second rotating body is formed by the second right-angled trapezoid union being rotated around the right-angled side of the second right-angled trapezoid union, and, at the same time, the second right-angled trapezoid union axially moves at constant speed along the central axis of the columnar body (3); wherein the second right-angled trapezoid union is formed by oppositely jointing two symmetrical upper sides of the two right-angled trapezoids; wherein the two right-trapezoids have identical lower sides and upper sides, and same and/or different right-angled sides; wherein the two right-trapezoids are coincident with the central axis of the columnar body (3).

3. The thread connection pair according to claim 1, wherein the bidirectional tapered internal thread (6) in the olive-like shape (93) comprises a first helical conical surface (421) of the tapered hole, a second helical conical surface (422) of the tapered hole, and an internal helical line (5);
a third shape formed by the first helical conical surface (421) of the tapered hole and the second helical conical surface (422) of the tapered hole is the same as a shape of a helical outer flank of a first rotating body, wherein the first rotating body is formed by a first right-angled trapezoid union being rotated around a right-angled side of the first right-angled trapezoid union, and, at the same time, the first right-angled trapezoid union axially moves at a constant speed along a central axis of the cylindrical nut (2); wherein the first right-angled trapezoid union is formed by oppositely jointing two symmetrical lower sides of two right-angled trapezoids; wherein the two right-trapezoids have identical lower sides and upper sides, and same and/or different right-angled sides; wherein the two right-trapezoids are coincident with the central axis of the cylindrical nut (2);
the bidirectional tapered external thread (9) comprises a first helical conical surface (721) of the truncated cone body, a second helical conical surface (722) of the truncated cone body, and an external helical line (8);
a fourth shape formed by the first helical conical surface (721) of the truncated cone body and the second helical conical surface (722) of the truncated cone body, is the same as a shape of a helical outer flank of the rotating body, wherein the rotating body is formed by the first right-angled trapezoid union being rotated around the first right-angled side of the first right-angled trapezoid union, and, at the same time, the first right-angled trapezoid union axially moves at constant speed along the central axis of the columnar body (3); wherein the first right-angled trapezoid union is formed by oppositely jointing two symmetrical lower sides of two right-angled trapezoids; wherein the two right-trapezoids have identical lower sides and upper sides, and same and/or different right-angled sides; wherein the two right-trapezoids are coincident with the central axis of the columnar body (3).

4. The thread connection pair according to claim 2, wherein when the right-angled trapezoid union rotates a circle at a constant speed, the axial movement distance of the right-angled trapezoid union is at least double the length of the sum of the right-angled sides of two right-angled trapezoids of the right-angled trapezoid union.

5. The thread connection pair according to claim 2, wherein when the right-angled trapezoid union rotates a circle at a constant speed, the axial movement distance of the right-angled trapezoid union is equal to the length of the sum of the right-angled sides of two right-angled trapezoids of the right-angled trapezoid union.

6. The thread connection pair according to claim 1, wherein the first helical conical surface (421) of the tapered hole and the second helical conical surface (422) of the tapered hole, and the internal helical line (5) are continuous helical surfaces or discontinuous helical surfaces, and/or the first helical conical surface (721) of the truncated cone body, the second helical conical surface (722) of the truncated cone body, and the external helical line (8) are continuous helical surfaces or discontinuous helical surfaces.

7. The thread connection pair according to claim 1, the dumbbell-like shaped bidirectional tapered internal thread (6) is formed by oppositely jointing two symmetrical upper sides of two tapered holes (3), wherein the two tapered holes have identical lower sides and upper sides, and same and/or different taper height; wherein the lower sides of the two tapered holes are located at two ends of the bidirectional tapered holes (41), and are respectively jointed with the lower sides of the adjacent bidirectional tapered holes;
the olive-like shaped bidirectional tapered internal thread (6) is formed by oppositely jointing two symmetrical lower sides of two tapered holes, wherein the two tapered holes have identical lower sides and upper sides, and same and/or different taper height; wherein the upper sides of the two tapered holes are located at two ends of the bidirectional tapered holes (41), and are respectively jointed with the upper side of the adjacent bidirectional tapered holes;
the dumbbell-like shaped bidirectional tapered external thread (9) is formed by oppositely jointing two symmetrical upper sides of two truncated cone bodies, wherein the two truncated cone bodies have identical lower sides and upper sides, and same and/or different taper height; wherein the lower sides of the two truncated cone bodies are located at two ends of the bidirectional truncated cone body (41), and are respectively jointed with the lower sides of the adjacent bidirectional truncated cone bodies;
the olive-like shaped bidirectional tapered external thread (9) is formed by oppositely jointing two symmetrical lower sides of two truncated cone bodies, wherein the two truncated cone bodies have identical lower sides and upper sides, and same and/or different taper height; wherein the upper sides of the two truncated cone bodies are located at two ends of the bidirectional truncated cone body (41), and are respectively jointed with the upper side of the adjacent bidirectional truncated cone bodies.

8. The thread connection pair according to claim 1, wherein the mutual thread fit of the internal thread (6) and the external thread (9) which form the thread pair (10) comprises different combinations such as the external thread (9) in the olive-like shape (93) with the left taper (95) smaller than the right taper (96) and the internal thread (6) in the dumbbell-like shape (94) with the left taper (95) greater than the right taper (96), and/or the external thread (9) in the dumbbell-like shape (94) with the left taper (95) greater than the right taper (96) and the internal thread (6) in the olive-like shape (93) with the left taper (95) smaller than the right taper (96).

9. The thread connection pair according to claim 1, wherein the internal thread (6) and the external thread (9) form the helical bidirectional tapered hole (41) and the helical bidirectional truncated cone body (71) are in fit under the guidance of the helical line to form cone pairs in pitches to form the thread pair (10); a clearance (101) is reserved between the bidirectional truncated cone body (71) and the bidirectional tapered hole (41); each pitch of internal thread (6) contains a corresponding pitch of external thread (9) for coaxial centering and to form a pair of sliding bearings; the whole thread connection pair (10) is composed of one or several pairs of sliding bearings; the number of the effective bidirectional joining (effective bidirectional contact) jointed containing and contained thread pitches of the internal thread (6) and the external thread (9) is designed according to the application conditions; and through the bidirectional containment of the truncated cone bodies (7) of the external thread (9) by the tapered hole (4) of the internal thread (6) and the positioning in multiple directions such as radial, circumferential, axial and angular directions, each pitch of internal thread (6) and external thread (9) comprises one-side bidirectional bearing and/or bidirectional bearing on left and right sides.

11. The thread connection pair according to claim 1, wherein the internal thread (6) and the external thread (9) form the thread pair (10), i.e., the first helical conical surface (421) of the tapered hole and the second helical conical surface (422) of the tapered hole and the first helical conical surface (721) of the truncated cone body and the second helical conical surface (722) of the truncated cone body matched with each other take the contact surface as the supporting surface to make the inner and outer cones are centered in inner and outer diameters under the guidance of the helical lines until the bidirectional conical surface (42) of the tapered hole is cohered with the bidirectional conical surface (72) of the truncated cone body to achieve one-directional bearing of the helical conical surface and/or bidirectional simultaneous bearing of the helical conical surface and/or until the fit and self-positioning contact and/or until the interference contact to produce self-locking.

12. The thread connection pair according to claim 1, wherein the columnar body (3) may be solid or hollow, comprising cylindrical and/or non-cylindrical workpieces and objects that need to be machined with the bidirectional tapered external threads (9) on the outer surfaces; the cylindrical body (2) comprises cylindrical and/or non-cylindrical workpieces and objects that need to be machined with the bidirectional tapered internal threads (6) on the inner surfaces; and the outer surfaces and/or inner surfaces comprise cylindrical surfaces and/or non-cylindrical surfaces such as conical surfaces, and other geometric shapes.

13. The thread connection pair according to claim 1, wherein the internal thread (6) and/or the external thread (9) comprises that the single pitch of thread body is an incomplete tapered geometry, that is, the single pitch of thread body is an incomplete unit thread.

14. The bidirectional tapered thread according to claim 1, wherein when the left taper (95) is same or approximately same with the right taper (96), the first taper angle (α1) is greater than 0° and smaller than 53°, and the second taper angle (α2) is greater than 0° and smaller than 53°;
when the left taper (95) is greater than the right taper (96), the first taper angle (α1) is greater than 0° and smaller than 53°, and the second taper angle (α2) is greater than 0° and smaller than 53′;
when the left taper (95) is smaller than the right taper (96), the first taper angle (α1) is greater than 0° and smaller than 53° and the second taper angle (α2) is greater than 0° and smaller than 53°.

15. The bidirectional tapered thread according to claim 12, wherein when the left taper (95) is same or approximately same with the right taper (96), the first taper angle (α1) is greater than or equal to 53° and smaller than 180°; the second taper angle (α2) is greater than or equal to 53° and smaller than 180°;
when the left taper (95) is greater than the right taper (96), the first taper angle (α1) is greater than or equal to 53° and smaller than 180°;
when the left taper (95) is smaller than the right taper (96), the second taper angle (α2) is greater than or equal to 53° and smaller than 180°.
